(19) United States
(12) Patent Application Publication
(10) Pub. No.: US 2002/0078460 A1
(43) Pub. Date: Jun. 20, 2002

(54) Video information reproducing apparatus and reproducing method of video information

(76) Inventors: Akira Shimazu, Kanagawa (JP); Yukiko Sakota, Kanagawa (JP)

Correspondence Address: William S. Frommer, Esq., FROMMER LAWRENCE & HAUG LLP, 745 Fifth Avenue, New York, NY, 10151, US

(21) Appl. No.: 09/923,083

(22) Filed: Aug. 6, 2001

(30) Foreign Application Priority Data
Aug. 8, 2000 (JP) 2000-239992

(51) Int. Cl. H04N 7/173

(52) U.S. Cl. 725/86; 725/89; 725/101

(57) ABSTRACT

It is an object of the present invention that reproduction can always be started excellently without waiting time in Near Video On Demand service. In a video information reproducing apparatus of a Near Video on Demand system in which the same program is distributed in a plurality of channels for a predetermined time difference, the reproducing apparatus has a record means recording in advance forefront data (a to c) of the program for the predetermined time difference, a digital signal reproduction means (15) or (14) reproducing the forefront data (a to c) of the predetermined time difference recorded in the record means (15) or (14), a memory means (14) which can perform data writing and data reading in parallel, and a control means (5) executing control in which the forefront data (a to c) is reproduced by the digital signal reproduction means (15) or (14) when the program is selected, data (c to b) following the forefront data (a to c) is written in the memory means (14) during the reproduction of the forefront data (a to c), and the following data is read and outputted from the memory means (14) continuously after the forefront data (a to c). This video information reproducing apparatus comprises a time information extract means (40) extracting time information in the program, and when the program is altered, the data recorded in the record means (15) or (14) is recorded over again onto the forefront data of the altered program, employing the time information obtained in the time information extract means (40) as a standard.

### BACKGROUND OF THE INVENTION

1. Field of the Invention

The present invention pertains to video information reproducing apparatuses and reproducing methods of video information which are applied to a terminal, for example, in a CATV and satellite broadcasting in which Near Video On Demand (NVOD; time difference distribution service) is adopted.

2. Description of the Related Art

Conventionally, a signal sent from a broadcasting station is an analogue video signal and audio signal. According to the development of recent digital techniques, a transmission signal from the broadcasting station has been made digital. Through the progress in data compression techniques represented by MPEG, for example, approximately 10 channels of digital signals have been able to be sent to an existing analogue 1 channel of a transmission band.

In a digital broadcast in which a data compression technique is utilized, considered is the provision of a service called Near Video On Demand by which video information of a movie or the like is distributed time-differently. This is the service wherein video information of the same movie or the like is transmitted giving time differences of a predetermined time and employing a plurality of channels. A subscriber only has to wait for this time difference at maximum in order to watch the video information of the movie or the like from the beginning.

However, in this service of the Near Video On Demand, there is a disadvantage that one has to wait, for example, for several minutes, until he/she can actually watch video information of a movie or the like from the time when an instruction of a reproduction start is given.

### SUMMARY OF THE INVENTION

The present invention was developed considering this problem, and it is an object of the present invention to provide a video information reproducing apparatus and a reproducing method wherein a reproduction start can always be performed excellently without waiting time in the Near Video On Demand service.

A video information reproducing apparatus according to the present invention is one in a Near Video On Demand system in which the same program is distributed in a plurality of channels for a predetermined time difference. The video information reproducing apparatus has a record means recording in advance forefront data of the program for the predetermined time difference, a digital signal reproduction means reproducing the forefront data of the predetermined time difference recorded in the record means, a memory means which can perform data writing and data reading in parallel, and a control means executing control so that the forefront data is reproduced by the digital signal reproduction means when the program is selected, data following the forefront data is written in the memory means during the reproduction of the forefront data, and the following data is read from the memory means to be outputted continuously after the forefront data, wherein a time information extract means extracting time information in the program is provided, and when the program is altered, the data recorded in the record means is recorded over again into the forefront data of the altered program, employing the time information obtained in the time information extract means as a standard.

With the present invention, since the forefront data of the predetermined time difference of the program recorded in advance is reproduced by the digital signal reproduction means according to a reproduction start request so that the data following the forefront data is written in the memory means during the reproduction of the forefront data to read and output the following data from the memory means continuously after the forefront data, reproduction can always be started without waiting time. Further, since the forefront data of the altered program is recorded over again employing the time information of the program when the program is altered, at the time of the reproduction start request, the connection between the forefront data of the program and the following data read from the memory means becomes excellent, and video information of a movie or the like can be reproduced excellently.

### BRIEF DESCRIPTION OF THE DRAWINGS

FIG. 1 is a block diagram illustrating an embodiment of a video information reproducing apparatus according to the present invention; and

FIG. 2 is charts serving to explain the present invention.

### DETAILED DESCRIPTION OF THE PREFERRED EMBODIMENT

An embodiment of a video information reproducing apparatus of the present invention is explained below referring to drawings.

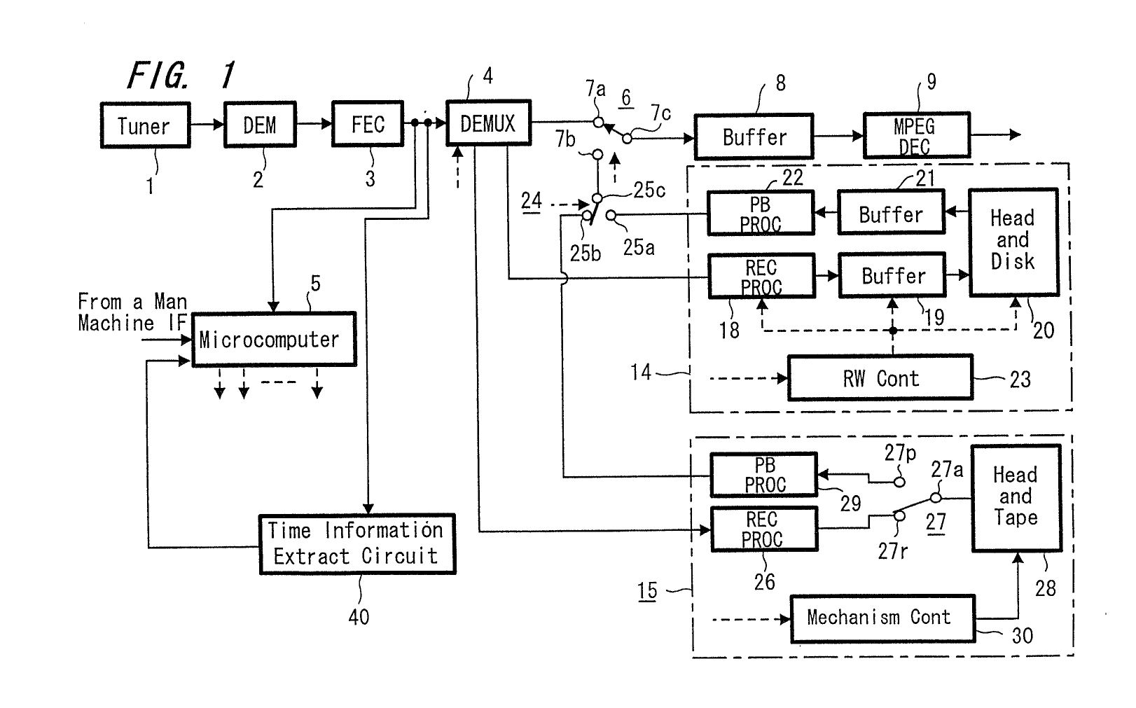

FIG. 1 illustrates a configurational example of a video information reproducing apparatus that is a terminal device in a Near Video On Demand system. In FIG. 1, reference numeral 1 denotes a tuner, and by this tuner 1, a desired channel of a broadcast signal transmitted from a head-end via, for example, an antenna, a cable, or the like, is selected.

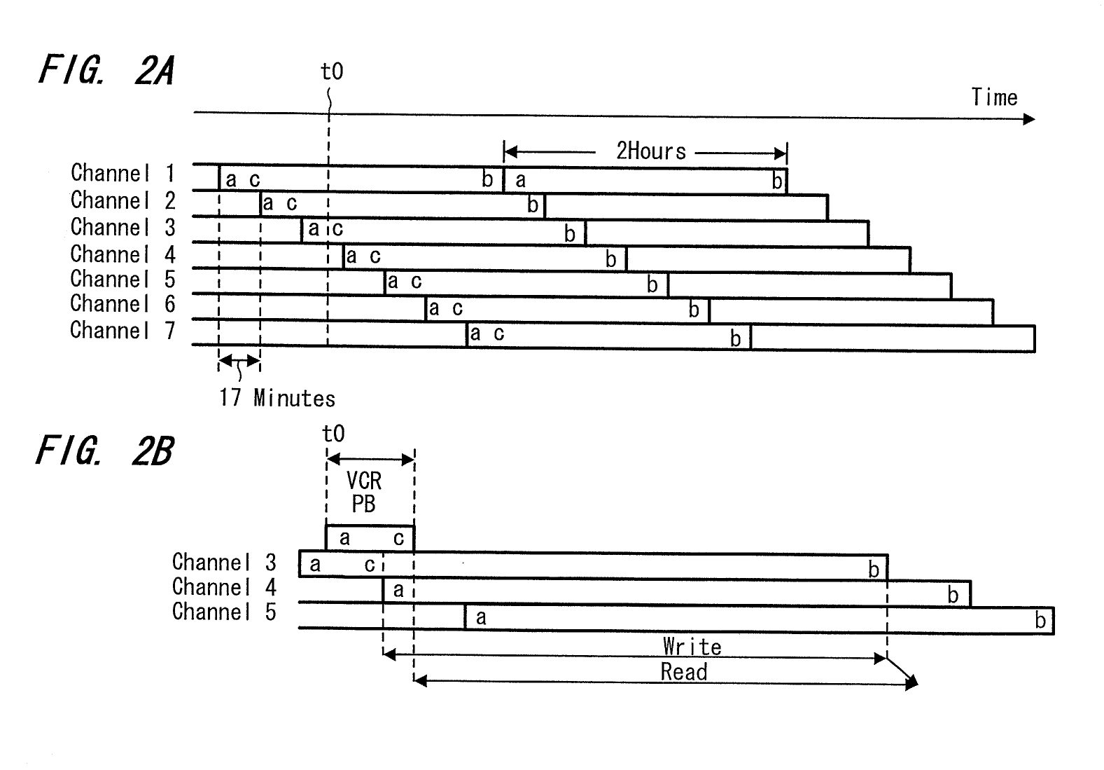

As one example of this Near Video On Demand system, 7 channels of the same video information compressed to the rate of 3.5 Mbps is supposed to be sent while the transmission capacity per 1 transmission channel is set to 24.5 Mbps or more. For example, when movie soft has a 2 hours content, from the relationship in which approximately 17 minutes is generated by dividing 120 minutes by 7, the time difference between channels is set to 17 minutes, for example, as shown in FIG. 2A.

The broadcast signal tuned in at the tuner 1 is supplied to a demodulator 2 to be demodulated, and the demodulated broadcast signal is supplied to an error correcting circuit 3. In this error correcting circuit 3, an error is detected and corrected so that an error generated in a communication path is corrected. This broadcast signal in which errors are corrected is supplied to a demultiplexer 4. This demultiplexer 4 selects desired one program from a plurality of programs. Thus, a control signal generated from a central processing unit 5 composed of a microcomputer (the signal paths of the control signal are shown in broken lines in FIG. 1) is supplied to the demultiplexer 4. A signal via a man machine interface such as a keyboard and a mouse is supplied to the central processing unit 5.

An output signal selected in the demultiplexer 4 is supplied to a fixed contact 7a of one side of a change-over switch 6. The broadcast signal obtained at a moving contact 7c of the switch 6 is supplied to an MPEG decoder 9 via a buffer 8. The decoded data decoded in the MPEG decoder 9 is supplied to a monitor via a baseband processing circuit which is not shown, and video information of a movie or the like is reproduced by the monitor. The demultiplexer 4 may be one by which data of a plurality of channels is simultaneously selected and is outputted.

Data of program arrangement information is sent from among the data whose error is corrected by the error correcting circuit 3 to the central processing unit 5. The central processing unit 5 selects a program to be stored (to be written) in a hard disk drive 14 as a storing device.

The program selected in the central processing unit 5 is supplied from the demultiplexer 4 to the hard disk drive 14 as the write data.

The hard disk drive 14 is composed of a record processor 18 for writing the data obtained from the demultiplexer 4, a buffer 19 connected to the record processor 18, head and disk 20 for writing the data from the buffer 19, a buffer 21 in which the data read out from the disk is stored, a playback processor 22 connected to the buffer 21, and a controller 23 for controlling writing and reading.

The control signal is supplied from the central processing unit 5 to the controller 23 so that the operation of the hard disk drive 14 is controlled by the central processing unit 5. An existing constitution may be employed as the hard disk drive 14, and its capacity is, for example, 40 GB.

The read data from the hard disk drive 14 is supplied to a fixed contact 25a of one side of a switch 24. The signal obtained at a moving contact 25c of the switch 24 is supplied to a fixed contact 7b of the other side of the switch 6.

The read data (reproduction data) obtained at the moving contact 7c of the switch 6 is supplied to the MPEG decoder 9 via the buffer 8 as described above.

Therefore, the read data (reproduction data) of the hard disk drive 14 can be reproduced by the monitor. The switching of the moving contact 7c of the switch 6 is controlled by a control signal from the central processing unit 5. The hard disk drive 14 is controlled by the central processing unit 5 so that writing and reading are implemented as if they are simultaneously performed.

Reference numeral 15 enclosed and shown by an alternate long and short dash line is a digital signal recording/reproducing device, for example, a digital VCR (video cassette tape recorder). This digital VCR 15 is composed of a record processor 26 to which the record data selected by a program selector 12 is supplied, a record/playback change-over switch 27 to which the record data from the record processor 26 is supplied to a recording side fixed contact 27r, a head and tape 28 for recording the data from the record processor 26 obtained at a moving contact 27a of the record/playback change-over switch 27, a playback processor 29 to which the data reproduced from the tape is supplied via a playback side fixed contact 27p of the record/playback change-over switch 27, and a mechanism controller 30 for controlling the recording and the writing.

The head and tape 28 has a helical scan type structure in which a magnetic tape is wound on a drum diagonally and the magnetic tape is scanned by a rotary head. The control signal from the central processing unit 5 is supplied to each of the moving contact 27a of the record/playback change-over switch 27 and the mechanism controller 30 so that the moving contact 27a and the mechanism controller 30 are controlled by the central processing unit 5. That is, the digital VCR 15 is constructed in such a manner that its recording and reproducing are controlled by the central processing unit 5.

In the digital VCR 15, the Near Video On Demand system is adopted wherein the same program is distributed through a plurality of channels for a predetermined time difference, and each time the program is altered, the data of the forefront of the programs is recorded over again for the predetermined time difference so that the forefront data is recorded in advance for the predetermined time difference. The program for the predetermined time difference can be directly recorded through a broadcast signal or can be recorded by a broadcast signal on a predetermined channel or a channel broadcasted at a predetermined time. That is, at first, it is possible to record through a program broadcasted, or to record through a channel transmitting a program for the predetermined time difference, or to divide regarding time a channel through which a program is broadcasted to broadcast the program for the predetermined time difference and record it.

As an example of the Near Video On Demand system, as shown in FIG. 2A, 7 channels (Channel 1 to Channel 7) are inserted into an existing analogue 1 channel so that a video program of 120 minutes is distributed at a time difference of a predetermined time (120 minutes divided by 7 equals approximately 17 minutes).

In FIG. 2, reference letter a denotes the top of a program, and reference letter b denotes the end of a program. In FIG. 2A, that the same program in each channel continues twice is for showing part of continuation of longer time (e.g. all day long).

In this case, the forefront data recorded by the digital VCR 15 is data (a to c) of 17 minutes of the forefront of a movie program.

In this case, the record processor 26 performs processing such as error correction encoding, formatting, and digital modulating for an input digital signal (digital video signal, digital audio signal, and the like). The playback processor 29 performs processing such as digital demodulation, format decomposition, and error correction.

The digital signal reproduced by the digital VCR 15 is supplied to a fixed contact 25b of the other side of the switch 24.

The mechanism controller 30 selects the forefront data of a program, for example, a movie, through the control signal from the central processing unit 5.

In the present example, the broadcast signal obtained in the output side of the error correcting circuit 3 is supplied to a time information extract circuit 40 extracting time information contained in the broadcast signal, and the time information obtained in the time information extract circuit 40 is supplied to the central processing unit 5 so that time information of a clock function that the central processing unit 5 has corresponds to the time information of the time information extract circuit 40.

The present example is constituted as described above, and when a user produces a reproduction request for a movie as a program at time to, first, the digital VCR 15 reproduces the forefront data (a to c) of the program recorded in advance in the digital VCR 15, and the reproduction signal is supplied to the monitor via the switch 24, switch 6, buffer 8, and MPEG decoder 9 so that the forefront data (a to c) can be watched as shown in FIG. 2B. In this case, the moving contact 25c of the switch 24 is connected to the fixed contact 25b of the other side, and the moving contact 7c of the switch 6 is connected to the fixed contact 7b of the other side by the central processing unit 5.

While the forefront data (a to c) is reproduced in the digital VCR 15, the channel in which data following the data c exists, that is, Channel 3 in the example of FIG. 2B, is selected by the central processing unit 5 as shown in FIG. 2B, and the hard disk drive 14 writes the data following the data c simultaneously.

Then, from the time the digital VCR 15 finishes reproduction of the forefront data (a to c) recorded in advance, the moving contact 25c of the switch 24 is switched and connected to the fixed contact 25a of one side, and the read data of the hard disk drive 14 is supplied to the buffer 8 via the switch 6 as shown in FIG. 2B so that a user can watch the following part of the data c. Thereafter, the hard disk drive 14 performs write operation and read operation in parallel, and the user can watch the movie by the data read out until the end b.

Therefore, according to the present example, video information, for example, a movie, can be watched without waiting time at the same time as a reproduction request.

In the present example, by distributed schedule information on a broadcast wave, it is announced that a program of the Near Video On Demand system is altered, and when the program is altered, the program selector 12 selects the altered program, for example, a movie, and the forefront data (a to c) for the predetermined time difference of the program is supplied to the digital VCR 15 so that the forefront data (a to c) for the predetermined time difference of the altered program is recorded in advance. In this case, time information contained in the broadcast signal as the program, obtained in the time information extract circuit 40, is recorded as a standard.

According to the present example, when the program is altered, recording of the forefront data (a to c) of the altered program is redone, employing the time information of the program. Thus, at the time of the reproduction request, the connection between the forefront data (a to c) of the program and the following data (c to b) read from the hard disk drive 14 becomes excellent, and video information of a movie or the like can be reproduced excellently.

In the example described above, the forefront data (a to c) of a program is recorded for a predetermined time difference and reproduced employing the digital VCR 15, however, in the example of FIG. 1, the digital VCR 15 may be omitted, the forefront data (a to c) may be recorded employing a predetermined area of the hard disk drive 14, the forefront data (a to c) may be reproduced at the same time as a reproduction request to be supplied to a monitor, and then the following data (c to b) may be read seamlessly from the hard disk drive 14 to be supplied to the monitor. In this case, it can be easily understood that similar interactions and advantageous effects to those of the example described above can also be obtained.

The present invention is not limited to the above-described example, and it is needless to say that other various configurations can be adopted without departing from the gist of the present invention.

With the present invention, since the forefront data of the predetermined time difference of the program recorded in advance is reproduced by the digital signal reproduction means according to a reproduction start request so that the data following the forefront data is written in the memory means during the reproduction of the forefront data and the following data is read out and outputted from the memory means continuously after the forefront data, reproduction can always be started without waiting time.

Further, since the forefront data of the altered program is recorded over again employing the time information of the program when the program is altered, at the time of the reproduction request, the connection between the forefront data of the program and the following data read from the memory means becomes excellent, and video information of such as a movie can be reproduced excellently.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. A video information reproducing apparatus in a Near Video On Demand system in which the same program is distributed in a plurality of channels for a predetermined time difference, the video information reproducing apparatus having a record means recording in advance forefront data of the program for the predetermined time difference, a digital signal reproduction means reproducing the forefront data of the predetermined time difference recorded in the record means, a memory means which can perform data writing and data reading in parallel, and a control means executing control in which the forefront data is reproduced by the digital signal reproduction means when the program is selected, data following the forefront data is written in the memory means during the reproduction of the forefront data, and the following data is read from the memory means to be outputted continuously after the forefront data,
wherein a time information extract means extracting time information in the program is provided, and when the program is altered, the data recorded in the record means is recorded over again onto the forefront data of the altered program, employing the time information obtained in the time information extract means as a standard.

2. The video information reproducing apparatus as set forth in claim 1, wherein the time information obtained in the time information extract means is employed as time information of the control means.

3. The video information reproducing apparatus as set forth in claim 1, wherein the control means detects that the program is altered through schedule information distributed by one channel among the plurality of channels and extracts time information by the time information extract means based upon the detection result to alter the program.

4. A video information reproducing apparatus in a Near Video On Demand system in which the same program is distributed in a plurality of channels for a predetermined time difference, the video information reproducing apparatus having a record means recording in advance forefront data of the program for the predetermined time difference on a recording medium on which data writing and data reading are performed in parallel, a digital signal reproduction means reproducing the forefront data of the predetermined time difference recorded in the record means, and a control means executing control in which the forefront data is reproduced by the digital signal reproduction means when the program is selected, data following the forefront data is written on the recording medium during the reproduction of the forefront data, and the following data is read from the recording medium to be outputted continuously after the forefront data,
wherein a time information extract means extracting time information in the program is provided, and when the program is altered, the data recorded in the record means is recorded over again onto the forefront data of the altered program, employing the time information obtained in the time information extract means as a standard.

5. The video information reproducing apparatus as set forth in claim 4, wherein the time information obtained in the time information extract means is employed as time information of the control means.

6. The video information reproducing apparatus as set forth in claim 4, wherein the control means detects that the program is altered through schedule information distributed by one channel among the plurality of channels and extracts time information by the time information extract means based upon the detection result to alter the program.

7. The video information reproducing apparatus as set forth in claim 4, wherein the recording medium is comprised of a hard disk, and the forefront data is recorded on a predetermined area of the hard disk so that the forefront data recorded in the predetermined area and data following the forefront data are seamlessly reproduced from the hard disk at the time of reproduction.

8. The video information reproducing apparatus as set forth in claim 4, wherein the time information obtained in the time information extract means is employed as time information of the control means so that the forefront data of the predetermined area on the hard disk is recorded.

9. A reproducing method of video information which employs a broadcast signal by which the same program is distributed in a plurality of channels for a predetermined time difference,
the video information reproducing method recording forefront data of the program on a recording medium on which data writing and data reading are performed in parallel in advance for the predetermined time difference,
reproducing the forefront data of the predetermined time difference recorded on the recording medium when reproduction of the program is selected,
and executing control in which data following the forefront data is written on the recording medium during the reproduction of the forefront data, and the following data is read and outputted from the recording medium continuously after the forefront data,
wherein time information in the program is extracted, and when the program is altered, the data recorded on the recording medium is recorded over again onto the forefront data of the altered program, employing the time information obtained in the time information extract means as a standard.

10. The reproducing method of video information as set forth in claim 9, wherein it is detected that the program is altered through schedule information distributed by one channel among the plurality of channels, and time information is extracted by the time information extract means based upon the detection result to alter the program.
